(19) United States
(12) Patent Application Publication
(10) Pub. No.: US 2008/0070186 A1
(43) Pub. Date: Mar. 20, 2008

(54) Holding Device

(76) Inventor: Heinrich Steger, Bruneck (IT)

Correspondence Address: LERNER GREENBERG STEMER LLP, P O BOX 2480, HOLLYWOOD, FL, 33022-2480, US

(21) Appl. No.: 11/838,315

(22) Filed: Aug. 14, 2007

(30) Foreign Application Priority Data
Aug. 14, 2006 (AT) GM 615/2006

(51) Int. Cl. A61C 3/00

(52) U.S. Cl. 433/75

(57) ABSTRACT

A holding apparatus (21), in particular a holding apparatus (21) which can be fastened to a carrier plate (2) of a copy milling device (1), for fixing a dental object (22), in particular a model body, wherein the in particular disk-shaped holding apparatus (21) has a through opening (11) for receiving the dental object (22) wherein at least one preferably movably mounted fastening means (23) which projects into the through opening (11) for fixing the dental object (22) is arranged or can be arranged at the holding apparatus (21).

The invention concerns a holding apparatus, in particular a holding apparatus which can be fastened to a carrier plate of a copy milling device, for fixing a dental object, in particular a model body, wherein the in particular disk-shaped holding apparatus has a through opening for receiving the dental object.

Copy milling devices are used in particular for the production of workpieces of a complicated three-dimensional shape. In that respect, a model body of a dental object is mechanically scanned by means of a scanning device, the deflections of the scanning pin being transmitted synchronously to a motor-driven machining tool and the machining tool, in a cutting machining operation, for example by milling or grinding, machining a shaped body identical to the model body, from a shaping blank. A copy milling device of that kind is described by way of example in the present applicant's Austrian patent application No A 1992/2004.

In that case the holding apparatus serves for fixing or fastening the model body and in general, just like the shaping blank to be machined, is fastened to the carrier plate of a copy milling device of that kind.

In the previously known holding apparatuses the dental object is glued into a receiving opening of a disk-shaped holding element of plastic material, wherein the receiving opening is generally milled and the outline of the receiving opening is matched to the contour of the model body.

Holding apparatuses of that kind admittedly represent a certainly satisfactory fastening option for the model body, but in particular the operation of milling out the receiving opening which is matched to the contour of the model body has proven to be complicated and time-consuming.

Therefore the object of the invention is to develop a holding apparatus of the kind referred to in the opening part of this specification, in such a way that fastening of the dental object in the holding apparatus is simplified.

That object is attained with the holding apparatus according to the invention in that at least one preferably movably mounted fastening means which projects into the through opening for fixing the dental object is arranged or can be arranged at the holding apparatus.

That measure according to the invention permits fastening of a dental object in the through opening of the holding apparatus by way of fastening means which are movable into the through opening so that, in contrast to the state of the art, the size of the through opening no longer plays an essential part, that is to say the outline of the through opening no longer has to be matched to the contour of the model body. In other words, the preferably movably mounted fastening means allow adaptation of the outline of the through opening to the contour of the model body.

A simple possible way of positioning the fastening means is achieved if, as an embodiment of the invention provides, the substantially flat holding apparatus has at least one guide path opening into the through opening for receiving the at least one, preferably bar-shaped fastening means, wherein, in accordance with a preferred embodiment, the holding apparatus at its top side has at least one guide path in channel or groove form.

It is particularly advantageous in that respect if the holding apparatus at its top side has a plurality of differently oriented guide paths which are in channel and/or groove form and which respectively open into the through opening and are adapted to receive a fastening means, so that this ensures that the dental object is held in the through opening by way of a plurality of fastening means engaging the peripheral surface of the model body at different points.

If in accordance with a further embodiment the holding apparatus is of an at least region-wise magnetic nature and the fastening means are formed by metal pins, that affords a solution which is particularly simple to handle and which prevents the fastening means from uncontrolledly slipping to and fro in the guide paths.

In that respect it is immaterial whether magnets are or can be arranged on the underside of the holding apparatus, preferably in opposite relationship to the guide paths provided on the top side or whether the guide paths themselves are magnetic.

In order also to reliably prevent the fastening means which are mounted in the guide paths from slipping in the scanning operation during a copy milling procedure, a further embodiment of the invention provides that the fastening means which are mounted in the guide paths and which project into the through opening for fixing the dental object are stationarily fastened in the guide paths, wherein in accordance with a preferred embodiment the fastening means are glued in position in the guide paths.

In contrast to the state of the art in which the receiving opening for the model body had to be laboriously milled out, having regard to the contour of the model body, the holding apparatus according to the invention represents a particularly simple fastening option for a dental object as the dental object can be introduced in a simple fashion into the through opening which has already been produced at the factory and then glued to the fastening means which are moved into position. In other words, with the holding apparatus according to the invention, the user only has to correctly position the fastening means in the guide paths while in the case of the holding apparatuses in accordance with the state of the art he had to carry out complicated and expensive and accurate milling operations.

The invention further concerns a copy milling device having a holding apparatus of the aforementioned kind, wherein the copy milling device advantageously includes a carrier plate to which the holding apparatus can be fastened.

The present invention also concerns a carrier plate for a copy milling device, to which a shaping blank can be fastened in particular by means of a holding element, and which has a holding apparatus according to the invention. Preferably in that case the holding apparatus can be fastened to the carrier plate by two-part inserts.

Furthermore the invention concerns a method of fastening a dental object in a holding apparatus of the kind set forth hereinbefore, wherein the dental object is introduced into the through opening, thereafter the fastening means mounted in the guide paths are positioned in such a way that they project into the through opening and extend with their free end to directly at the surface of the dental object or touch same, and in a further succession the fastening means are glued fast in that position in the guide paths before the dental object is glued to the free ends of the fastening means.

Further advantages and details of the invention are described more fully by means of the specific description hereinafter with reference to the embodiments illustrated in the drawing in which:

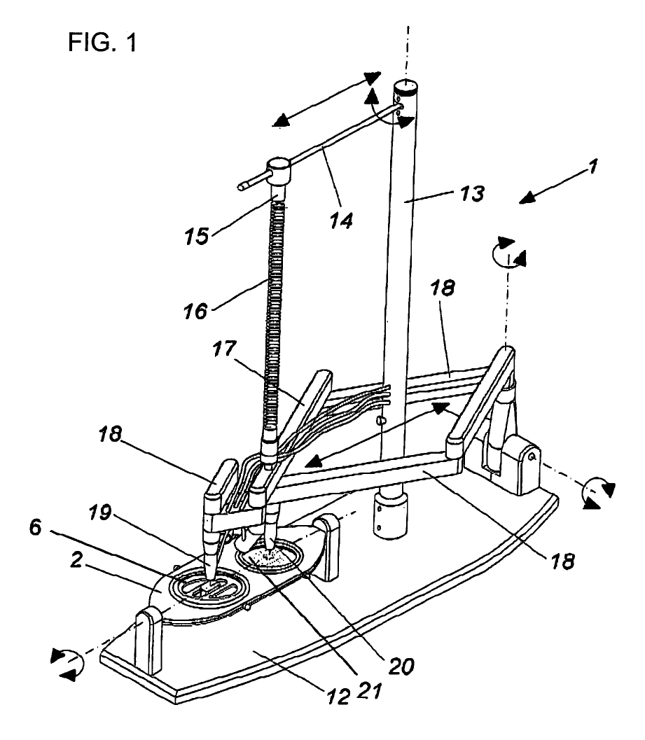

FIG. 1 shows a perspective view of a copy milling device,

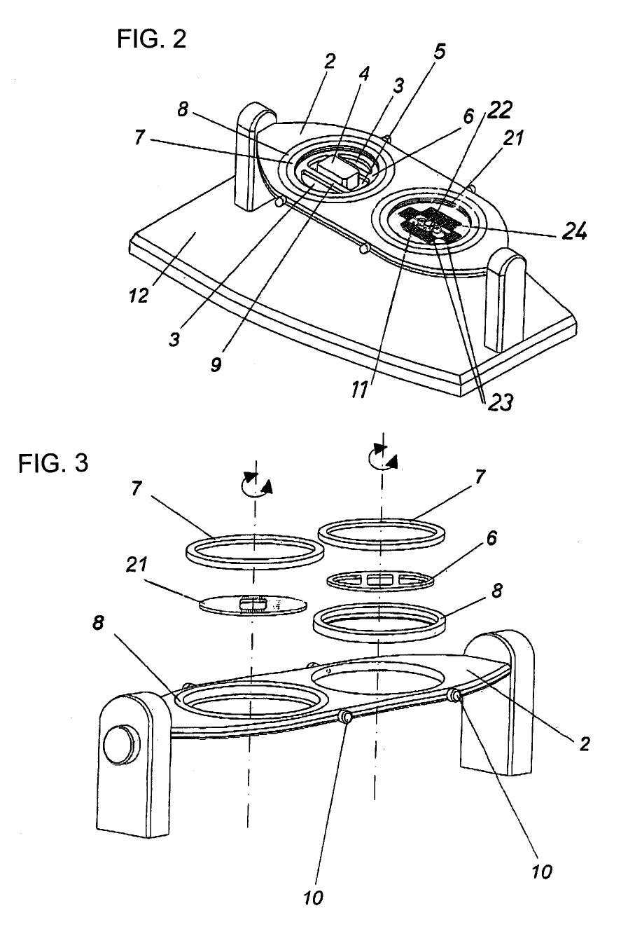

FIG. 2 shows a carrier plate with a holding apparatus according to the invention, and a holding element,

FIG. 3 shows an exploded view of a carrier plate with two-part inserts for fastening a holding apparatus and a holding element, and

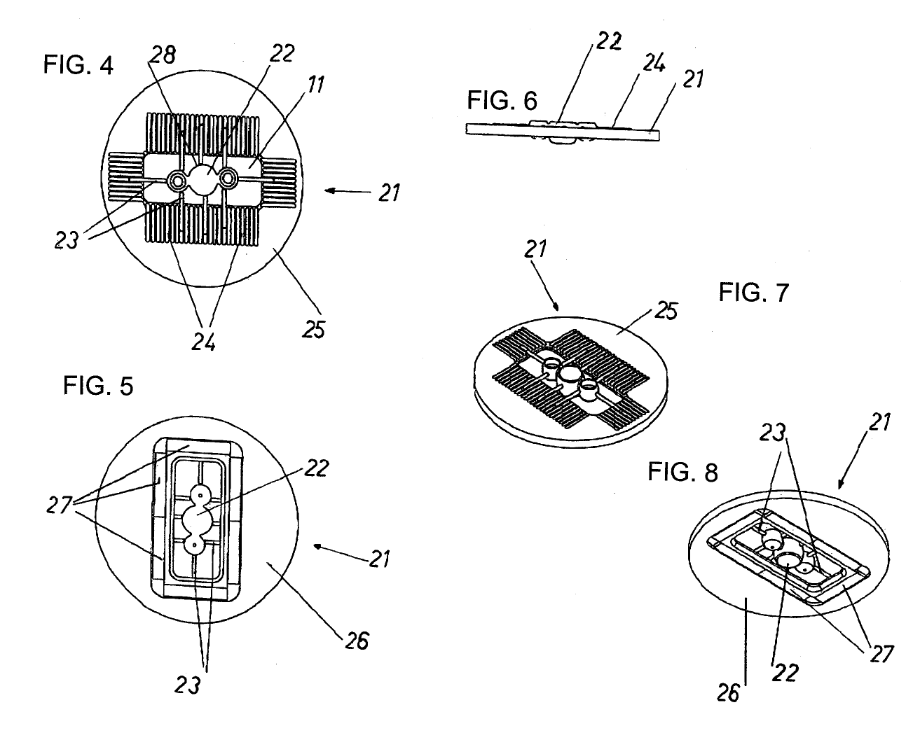

FIGS. 4, 5, 6, 7 and 8 show different views of embodiments of a holding apparatus according to the invention.

FIG. 1 diagrammatically shows a copy milling device 1, in which respect in particular it is possible to see the carrier plate 2. Arranged on a base plate 12 is a vertical carrier 13 on which a support 15 for a spring 16 is mounted by way of a holding apparatus 14. The support 15 is mounted to the holding apparatus 14 displaceably in the longitudinal direction of the holding apparatus 14. That ensures that the support 15 of the spring 16 can follow the point of engagement of the spring 16 on the arm 17 upon changes in position so that the spring 16 is oriented substantially vertically throughout the entire milling operation. A motor-driven processing tool 19 for milling the shaping blank as well as a scanning device 20 for scanning the dental model body are arranged by way of a pantograph-like arrangement of levers 18 which are rotationally angularly connected together.

Arranged on the carrier plate 2 is a holding element 6 for fastening a shaping blank as well as a holding apparatus 21 according to the invention for fixing a model body.

FIG. 2 shows a detail view of a carrier plate 2. It will be seen that the carrier plate 2 has a holding element 6 for a shaping blank 4, wherein the holding element 6 is fastened to the carrier plate 2 by means of two-part inserts 7, 8. The shaping blank 4 is fastened by adhesive dots to the limbs 9 of the holding element 6. It is possible to clearly see the through openings 3 which are arranged at both sides of the shaping blank 4 and through which the dust which is produced when milling the shaping blank can pass in the direction of the base plate 12 through carrier plate 2. It is also possible to see that a dental object 22 serving as a model body is fastened to the carrier plate 2 in a through opening 11 of the holding apparatus 21 according to the invention. The holding apparatus 21 has guide paths 24 in which are mounted fastening means 23 which are of bar form and which project into the through opening 11 for fixing the dental object 22.

In FIG. 3 which shows an exploded view, it is possible to see the fastening of the holding apparatus 21 and a holding element 6 to the carrier plate 2 by means of the two-part inserts 7, 8. In that case firstly the lower part 8 of the two-part insert 7, 8 is fitted into the through opening in the carrier plate 2. There then follow the holding apparatus 21 and the holding element 6 respectively which are clamped fast with the upper part 7 of the two-part insert 7, 8. The two-part inserts 7, 8 can be rotated about the vertical axis illustrated and fixed by means of the taper screws 10.

The holding apparatus 21 according to the invention can be seen in detail from the different views shown in FIGS. 4 through 8.

Therein FIG. 4 shows a plan view of a first embodiment in which the holding apparatus 21 is of a circular configuration. A plurality of guide paths 24 are arranged on the top side 25 of the holding apparatus 21 in such a way that with one end they open into the through opening 11 which is of a rectangular configuration in the illustrated embodiment, wherein the arrangement of the guide paths 24 on the holding apparatus 21 is such that a plurality of guide paths 24 open on each side of the rectangular through opening 11. Metallic fastening means 23 in pin form are mounted in some of those guide paths 24, the fastening means 23 extending directly to the surface 28 of the dental object 22 or touching same.

In order to prevent the fastening means 23 uncontrolledly moving in the guide paths 24, a plurality of magnets 27 are arranged on the underside 26 of the holding apparatus 21 according to the invention, as can be seen in particular from FIG. 5, more specifically in opposite relationship to the guide paths 24 on the top side 25. It will be appreciated that it would also be possible for the guide paths 24 themselves to be magnetic or however for the fastening means 23 to be magnetic.

FIG. 6 shows a side view of a holding apparatus 21 according to the invention while FIG. 7 shows a perspective inclined view from above onto a holding apparatus 21 and FIG. 8 shows a perspective inclined view from below onto an embodiment of the invention.

For reasons of clarity, the adhesive means with which on the one hand the fastening means 23 are glued in the guide paths 24 and on the other hand the dental object 22 is glued to the free ends of the fastening means 23 are not shown.

The illustrated embodiments of holding apparatuses for dental objects as well as the described example of a possible method of fastening a dental object in a holding apparatus according to the invention are obviously not to be interpreted in a restrictive sense but are only individual examples of numerous possible ways of implementing the concept of the invention of a holding apparatus for in particular dental objects with an irregular surface.

1-15. (canceled)

16. A holding apparatus assembly for fixing a dental object, comprising:
a holding apparatus formed with a through opening for receiving the dental object; and
at least one fastening device disposed to project into said through opening for fixing the dental object and configured for attachment at said holding apparatus.

17. The holding apparatus assembly according to claim 16, which further comprises a carrier plate of a copy milling device, and wherein said holding apparatus is mounted to said carrier plate.

18. The holding apparatus assembly according to claim 17, wherein said copy milling device is a dental milling device and the dental object is a model body.

19. The holding apparatus assembly according to claim 16, wherein said holding apparatus is substantially disk-shaped.

20. The holding apparatus assembly according to claim 17, wherein said fastening device is movably mounted.

21. The holding apparatus assembly according to claim 16, wherein said holding apparatus is a substantially flat holding apparatus formed with at least one guide path opening into said through opening for receiving said fastening device.

22. The holding apparatus assembly according to claim 21, wherein said at least one guide path is configured for receiving a bar-shaped said fastening device.

23. The holding apparatus assembly according to claim 16, wherein said holding apparatus has a top side formed with at least one guide path in channel or groove form.

24. The holding apparatus assembly according to claim 16, wherein said holding apparatus has a top side formed with a plurality of differently oriented guide paths in channel and/or groove form, respectively opening into said through opening, and adapted to receive a fastening means.

25. The holding apparatus assembly according to claim 16, wherein said holding apparatus is magnetic at least in portions thereof.

26. The holding apparatus assembly according to claim 16, which comprises a plurality of magnets disposed on an underside of said holding apparatus.

27. The holding apparatus assembly according to claim 24, which comprises a plurality of magnets disposed on an underside of said holding apparatus in opposite relationship to said guide paths formed on said top side.

28. The holding apparatus assembly according to claim 25, wherein said guide paths are magnetic.

29. The holding apparatus assembly according to claim 16, wherein said at least one fastening device is one of a plurality of fastening devices formed of metallic pins.

30. The holding apparatus assembly according to claim 16, wherein said holding apparatus is formed with a plurality of guide paths opening into said through opening, and said at least one fastening device is one of a plurality of fastening devices stationarily mounted in said guide paths and projecting into said through opening for fixing the dental object.

31. The holding apparatus assembly according to claim 30, wherein said fastening devices are glued in position in said guide paths.

32. A copy milling device, comprising a holding apparatus assembly according to claim 16.

33. The copy milling device according to claim 32, which further comprises a carrier plate configured for mounting said holding apparatus thereto.

34. A carrier plate for a copy milling device, comprising a fastening assembly for fastening a shaping blank to the carrier plate, and a holding apparatus according to claim 16.

35. The carrier plate according to claim 34, wherein said fastening assembly includes a holding element.

36. The carrier plate according to claim 34, which comprises two-part inserts for fastening said holding apparatus to the carrier plate.

37. A method of fastening a dental object, which comprises:
providing a holding apparatus assembly according to claim 16;
introducing the dental object into the through opening;
thereafter positioning the one or more fastening devices in the guide paths to project into the through opening and extend with a free end thereof directly at a surface of the dental object or touch the dental object to define a given position; and
subsequently gluing the fastening devices in the given position in the guide paths before the dental object is glued to the free ends of the fastening devices.
